(19) United States
(12) Patent Application Publication
(10) Pub. No.: US 2017/0169501 A1
(43) Pub. Date: Jun. 15, 2017

(54) METHOD AND SYSTEM FOR EVALUATING FITNESS BETWEEN WEARER AND EYEGLASSES

(71) Applicant: Essilor International (Compagnie Générale d'Optique), Charenton-le-Pont (FR)

(72) Inventor: Lin XIA, Shanghai (CN)

(21) Appl. No.: 15/378,964

(22) Filed: Dec. 14, 2016

(30) Foreign Application Priority Data
Dec. 14, 2015 (CN) 201510922881.7

(51) Int. Cl. G06Q 30/06; G06K 9/62; H04N 5/232; G06K 9/00

(52) U.S. Cl. CPC G06Q 30/0631; G06Q 30/0643; G06K 9/00248; G06K 9/6202; H04N 5/23293

(57) ABSTRACT

A method and system for evaluating fitness between a wearer and eyeglasses worn by the wearer, the method comprising steps of: generating facial attribute data associated with the wearer; generating attribute data of the eyeglasses; establishing wearer model based on the facial attribute data; establishing eyeglasses model based on the eyeglasses attribute data; comparing the wearer model and the eyeglasses model and evaluating the fitness there between; and generating a rating score information indicative of to which extent the eyeglasses improves the wearer visage based on the fitness evaluation result. By means of this method, the wearer of the eyeglasses can easily learn the matching/fitness degree of the eyeglasses worn by the wearer with his or her face, so as to help the wearer to decide whether or not to purchase or use the eyeglasses.

### FIELD OF THE INVENTION

The present invention relates to the field of artificial intelligence modeling techniques for face recognition, and more particularly to a method and system for evaluating fitness between a wearer and eyeglasses worn by the wearer.

### BACKGROUND OF THE INVENTION

With the emergence of more and more styles of eyeglasses on the market, people have more choices in order to obtain appropriate eyeglasses. At the same time, as the eyeglasses having different functions are used by people, the function of the eyeglasses is not limited to satisfying the optical functions thereof, and it can also has a function of increasing the beauty (aesthetic). For example, different models of non-lens frame and sunglasses can match different faces and scenes, so that the wearer may obtain a higher aesthetic, similar to the effect of different clothing.

The aesthetic feature of the eyeglasses makes people to consider more factors when choosing eyeglasses. However, due to the lack of appropriate expertise, and when faced with a variety of styles of glasses, ordinary eyeglasses wearers cannot quickly and satisfactorily obtain and select the appropriate eyeglasses, so as to achieve the above objectives.

In the prior art, there are a variety of methods and systems which are capable of selecting one or several pairs of eyeglasses from a list of eyeglasses based on the face of a wearer, according to a certain algorithm.

These recommended methods and systems do provide convenience for the wearer to select eyeglass, however, this recommendation is not intuitive. Especially when being recommended of a number of glasses, the wearer is still faced with the difficult problem of choice, and still cannot obtain the appropriate eyeglasses.

### BRIEF DESCRIPTION OF THE DRAWINGS

It is to be understood that all features, modifications and/or embodiments may be combined according to various combinations, except insofar as they are clearly contradictory or incompatible in the present invention. Other features and advantages of the present invention will become apparent from the following description of a non-limiting illustrative embodiment, referring to the following drawings, in which:

FIG. 1 shows a flow diagram of a method according to the invention;

FIG. 2 shows a flow diagram of a step of comparative evaluation in the method according to the invention; and

FIG. 3 shows a system according to the invention.

The illustrated figures are only exemplary and are not intended to assert or imply any limitation with regard to the environment, architecture, design, or process in which different embodiments may be implemented.

### DETAILED DESCRIPTION

It should to be noted that the object of the present invention is to overcome one or more of the above-mentioned disadvantages.

To this end, according to the present invention, a method for evaluating fitness between a wearer and eyeglasses worn by the wearer is provided, the method comprising the steps of:
generating facial attribute data associated with the wearer;
generating eyeglasses attribute data of the eyeglasses;
establishing wearer model based on the facial attribute data;
establishing eyeglasses model based on the eyeglasses attribute data;
comparing the wearer model and the eyeglasses model and evaluating the fitness there between; and
generating a rating score information indicative of to which extent the eyeglasses improves the wearer visage based on the fitness evaluation result. In this method, when selecting eyeglasses, a wearer can easily know the matching/fitness degree of the eyeglasses worn by the wearer with their appearance, and can visually know whether the aesthetic is increased or decreased after wearing the eyeglasses, so as to decide whether or not to purchase or use the eyeglasses based on the score information.

According to different embodiments of the present invention, one or more of the following features may be used:

Further, according to the method of the present invention, the step of generating the facial attribute data comprises steps of:
capturing at least one image of the wearer, wherein the image is a two-dimensional or three-dimensional image;
detecting a face in the image; and
characterizing facial attributes of the wearer, such as identification and calibration of each main feature on the face (face width, eye width, etc.).

Through these steps, more accurate facial feature information can be obtained, so as to facilitate the subsequent steps.

Further, according to the method of the present invention, the wearer receives information including at least one image of him fitted with the eyeglasses along with the corresponding rating score information. In addition, the information can be shared via social network. Through these steps, the wearer can obtain more intuitive evaluation on the choice and wearing of eyeglasses and more feedback through social networking sites, so as to more conveniently obtain the matching/fitness degree of wearing the eye glasses.

Further, according to the method of the present invention, the wearer receives a recommendation of other eyeglasses which would bring higher rating score, so that the wearer can choose more suitable eyeglasses based on the score.

Further, according to the method of the present invention, the selected eyeglasses or the recommended glasses is linked to an on-line store where the wearer can purchase the eyeglasses, so that the wearer can purchase satisfactory eyeglasses after knowing the score.

Alternatively, according to the method of the present invention, the step of generating eyeglasses attribute data includes the step of obtaining the characteristics of the eyeglasses frame and the lens from the eyeglasses manufacturer, which facilitates professional model building and enables the eyeglasses manufacturer to more directly obtain the requirements from wearers.

Further, according to the method of the present invention, the step of establishing wearer model comprises a step of establishing metadata of the wearer, the metadata of the wearer at least comprising:
metadata on face shape of the wearer;
metadata on eye shape of the wearer.

In addition, the step of establishing eyeglasses model comprises a step of establishing metadata of the eyeglasses which includes the characters of the eyeglasses frame and lens.

As it should be, the metadata of the wearer and the metadata of the eyeglasses may further include other relevant metadata as long as the metadata can be used for later comparative analysis and evaluation.

Further, according to the method in the present invention, the step of comparing the wearer model and the eyeglasses model and evaluating fitness there between comprises steps of:
pre-evaluating the wearer model and the eyeglasses model in a kernel database;
comparing and evaluating the metadata of the wearer in the kernel database;
comparing and evaluating the metadata of the eyeglasses in the kernel database; and
generating an evaluation matrix on the basis of the above steps.

Advantageously, the kernel database at least comprises a database of wear models and a database of eyeglasses models which are obtained by big data analysis and is adapted to be updated by adding new wear models and/or eyeglasses models when they are not included in the kernel database.

In addition, alternatively, the step of creating a rating score further comprises a step of creating weighted scores on the basis of the evaluation matrix.

Based on the above steps, the final score can be more objective and credible due to the use of the kernel database and large data sample collection and analysis model. Furthermore, the kernel database can be continuously updated and improved with evaluation from different wearers by learning the expansion model, which is also in favor of the more reasonable final score.

In addition, the present invention further relates to a system for evaluating fitness between a wearer and eyeglasses worn by the wearer, the system comprising:
an attribute data generating module for generating facial attribute data associated with the wearer and eyeglasses attribute data;
a model establishing module for establishing wearer model based on the facial attribute data and eyeglasses model based on the eyeglasses attribute data;
an evaluating module for comparing the wearer model and the eyeglasses model and evaluating fitness there between; and
a rating score generating module for generating and indicating a rating score regarding to which extent the selected eyeglasses improves the wearer visage on the basis of the fitness evaluation result.

By means of this system, the wearer can easily know whether and to which extent the eyeglasses they wear can increase their beauty.

Further, the system further comprises an image capture device for capturing at least one image of the wear. The image capture device is a two-dimensional or three-dimensional camera. As it should be, other image acquisition devices, such as video cameras, as well as scanners for directly scanning the photographs of a wearer, also can be used. Alternatively, the wearer can also upload their photos directly into the system.

Further, the system further comprises a displaying device for displaying at least one image showing how the wearer would appear wearing the eyeglasses along with the corresponding rating score. The score may be a numerical score, a color score, or other visual graphical score to facilitate the wearer obtain the specific scoring results in an intuitive and convenient manner. In addition, the images and ratings can be shared through social networks.

Furthermore, the present invention further relates to a method for evaluating fitness between a wearer and a head-worn device worn by the wearer, the method comprising steps of:
generating facial attribute data associated with the wearer;
generating attribute data of the head-worn device;
establishing wearer model based on the facial attribute data;
establishing head-worn device model based on the head-worn device attribute data;
comparing the wearer model and the head-worn device model and evaluating the fitness there between; and
generating a rating score information indicative of to which extent the head-worn device improves the wearer visage based on the fitness evaluation result.

The above-mentioned head-worn device may be, for example, a headgear, a headphone, a face mask, or the like, which needs to be evaluated when being worn.

Finally, the present invention further relates to a computer program product comprising a series of instructions. When loaded into a computer, this instructions causes the computer or a hardware system to perform the steps of a method according to the invention.

It should be noted that terms such as “calculation”, “comparison”, “evaluation” and the like, as used in this specification, refer to the operation and/or processing of a computer or computing system or similar electronic computing device. The amount of operations and/or converted data displayed in the registers and/or memory of the computing system in form of physical (e.g., electronic) quantities and the quantities in the registers and/or memory of the computer system may be converted into the same data in the registers of the computing system or other Information storage, transmission or display device in the computing system in the form of physical quantities.

The processing or display in the present specification is not limited to a particular computer or other device. A variety of general purpose systems may be used with the programs according to the teachings herein. In addition, embodiments of the invention are not described with reference to any particular programming language. It will be appreciated that various programming languages may be used to perform the teachings of the present invention as described herein.

With the above arrangement, the present invention provides a method and system for evaluating fitness between a wearer and eyeglasses worn by the wearer. By means of the present invention, the wearer of the eyeglasses can easily obtain the effect of increasing the beauty by wearing the eyeglasses, so that it is possible to quickly decide whether to purchase or wear the eyeglasses. At the same time, through the sharing of social networks, the wearer can obtain more comprehensive feedback and sharing, for better social interaction. In addition, the invention also allows the lens manufacturer to quickly and promptly understand the wearer's wear requirements, to do more personalized recommendations and production, so as to enhance customer interaction and improve the customer's experience.

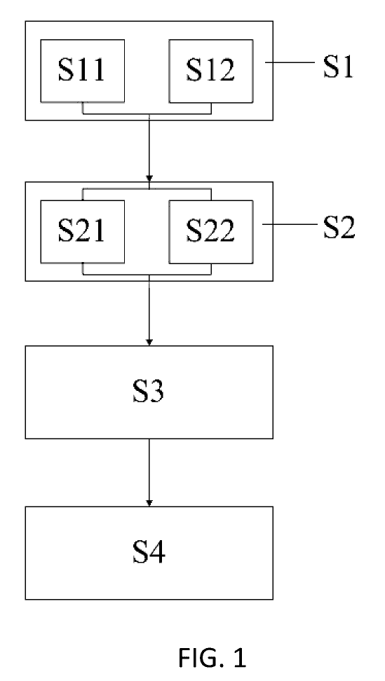

Referring to FIG. 1, it shows a flow diagram of one embodiment of a method according to the present invention. Wherein, step S1 is a step of generating attribute data which includes a step S11 of generating facial attribute data associated with the wearer and a step S12 of generating attribute data of the eyeglasses. Step S2 is a step of establishing eyeglasses models including a step S21 of establishing the wearer model and a step S22 of establishing eyeglasses model. Step S3 is a step of comparative evaluation. Step S4 is a step of scoring.

Specifically, firstly in step S1, attribute data of a wearer's face (step S11) and the eyeglasses (step S12) are respectively generated.

In step S11, for the attribute data of the wearer's face, for example, it is necessary to firstly obtain the wearer's face image. The image may be captured by a two-dimensional or three-dimensional camera or a video camera, or may be obtained by uploading a wearer's photo or scanning a photograph, and then is recognized for recognizing the basic feature points for face judgment, eye judgment, and lip judgment. For example, standard face feature points are obtained based on the open source code base known to a person skilled in the art based on OPENCV (Open Source Computer Vision Class Library). Other key points of the head: including face height and face width and other attributes can be obtained based on OPENCV key point analysis to redefine the forehead, hair and other elements.

Similarly, in step S12, the eyeglasses attribute data may be scanned, for example, by a two-dimensional or three-dimensional scanner, and then acquired by a predetermined algorithm, such as mirror type, mirror size, mirror color and the like. As it should be, these features may also be provided by the eyeglasses manufacturer.

Then, in step S2, wearer model (step S1) and eyeglasses model (step S12) are respectively established based on the facial attribute data and eyeglasses attribute data obtained in step S1.

Specifically, in step S21, facial attribute data is mainly used for face determination and eye shape determination.

Face determination is mainly based on face modeling by learning and summarizing judgment methods, such as Boych morphological judgment, the Chinese standard judgments, and Asian standard judgment and the like. Based on these standards, a data modeling is made for the face, such as setting the following 12 dimensions to infer the basic data of the face.

| | |
|---|---|
| 1 | Ratio of face length to face width |
| 2 | Ratio of face length to eyes width |
| 3 | The height of the widest part of the face |
| 4 | Ratio of the distance between the eyes to the width of the |
| | face at the same height on the face |
| 5 | Ratio of the average size of the eyes to the face width at |
| | the same height on the face |
| 6 | Ratio of the face width at 20% of the height to the face |
| | width at 80% of the height |
| 7 | Ratio of the lip width to the face width at the same height |
| | on the face |
| 8 | Ratio of the distance between the pupils to the distance |
| | between the pupils and the base of the nose in the Y-axis |
| | direction |
| 9 | Ratio of the distance between the center portion of the left |
| | eyebrow and the left pupil in the Y-axis direction to the |
| | face length |
| 10 | Ratio of the distance between center portion of the right |
| | eyebrow and the right pupil in the Y-axis direction to the |
| | face length |
| 11 | Ratio of the distance between the bottom of the lip and the |
| | face to the face length |
| 12 | Chin angle |

By means of the attribute value of the above various dimensions, the model of the basic face will be established to obtain the model number of the wearer, such as the square face-A, the round face-C, so as to establish the meta-data related to the face.

Similarly, eye shape determination is mainly relied on the distance between the eyes and the location of the bridge of the nose to build the eye model, including the following dimensions:

| | |
|---|---|
| 1 | Ratio of the distance between the left canthus of left eye and |
| | the left pupil center to left eye height |
| 2 | Ratio of the distance between the left canthus of right eye |
| | and the right pupil center to right eye height |
| 3 | Ratio of the height of the pupil to the average height of the |
| | eyes |
| 4 | Ratio of the distance between two eyes to the average height |
| | of two eyes |

According to the eye shape determination based on the feature values of the respective dimensions, the eye shape model is established and the wearer's eye shape is determined, for example, as slanted eyes-A, dropping eyes-B, or almond eyes-C, etc., to establish eye shape related metadata.

In step S22, the eyeglasses determination is performed, and the eyeglasses model is built from a variety of dimensions including the lens type, the lens size, the lens color and the lens thickness. The eyeglasses attributes are classified, and the key information of features is marked, including:

| | |
|---|---|
| 1 | Eyeglasses frame |
| 2 | Full frame - half frame |
| 3 | The average thickness of the eyeglasses |
| 4 | Eyeglasses color |
| 5 | Eyeglasses size |
| 6 | Eyeglasses material |
| 7 | Lens color |
| 8 | Lens thickness |
| 9 | Eyeglasses style |

According to the above determination, a model of the eyeglasses is established, and the characteristics of the spectacle are determined, thereby establishing the metadata relating to the eyeglasses.

Next, these models (metadata) are compared and evaluated (step S3) after obtaining the wearer model (metadata) and the eyeglasses model (metadata).

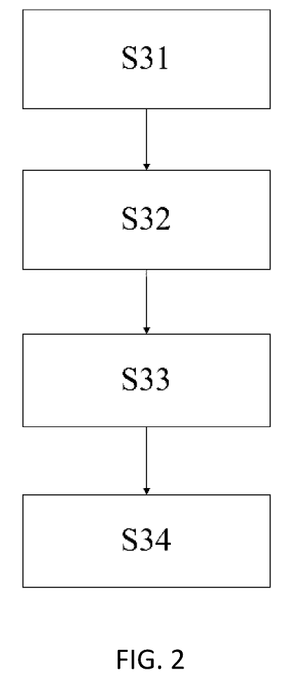

The core of this step S3 is a calculation that is accumulated and optimized by a series of empirical values. Preferably, as shown in FIG. 2, the step comprises:

Step S31: According to the kernel database, the overall beauty of the wearer and the eyeglasses to be worn is preliminarily identified, and a preliminary evaluation score (for example, an experience score) is given.

Step S32: The eyeglasses model (metadata) is compared and analyzed with the separated characteristics of all the face data in the kernel database (for example, the above-mentioned 12 face features and the 4 eye features) to determine which face features are suitable for this eyeglasses, and which types of facial features are not suitable for this eyeglasses, and gives an corresponding score;

Step S33: After comparing all eyeglasses models, the wearer model (metadata) is compared and analyzed with the separated characteristics of all eyeglasses data in the kernel database (e.g., the nine eyeglasses attributes described above) to determine whether suitable for the wearer, and give an appropriate score;

Wherein, if the face shape of the wearer cannot be matched with the kernel database, e.g., the wearer's face features are not found or recognized, or if the wearer's characteristics are not found where there is theoretical value, and thus the basic face model is not formed, then the kernel database need to be added or adjusted. The closest basic face model then is selected from the kernel database (for example, only face features are considered) and the recommended score is given. At the same time, an exception handling process is added to re-model this kind of face.

Step S34: In combination with the data of steps S32 and S33, the eyeglasses attribute and the face attribute may be combined to calculate the weight value of a certain face model and a certain feature of the eyeglasses and generate an evaluation matrix. For example, the evaluation matrix can be two-dimensional, the vertical direction corresponding to the face features, horizontal direction corresponding to the eyeglasses features, but also can be a higher dimension, in order to obtain more accurate and detailed evaluation results.

Wherein, the kernel database can be obtained on the basis of experience, or can also be derived on the basis of theory.

On the basis of the experience, for example, there exist the following situations: round face is generally matched with angular eyeglasses, not circular eyeglasses; oval face is generally matched with almost any eyeglasses, but not eyeglasses in too large size; heart-shaped face is generally matched with square eyeglasses; square face is generally matched with oval and round eyeglasses, not square eyeglasses; pear-shaped face is generally matched with half-rimmed glasses, not too narrow eyeglasses and so on. Through the experience of matching, the kernel database can be established by the general computer database model.

In the case of theoretical derivation, for example, a real-world model can be searched and matched by a sample image, for example, several sets (e.g., 50 to 100 sets) of real facial models can be created to cover essentially all Asian or European faces. The comparison of different combinations of face features and eyeglasses characteristics is then established based on the above-mentioned model features (model dimensions), for example, comparing and establishing the base data in steps S32 and S33 in step S3 of a similar comparison and evaluation, so as to obtain kernel database. The kernel database may be in the form of a matrix or other set of numbers.

In addition, step S3 may further comprises the step of acquiring and referring to other personalized characteristics of the wearer, such personalization characteristics may comprises: the age of the wearer, the career of the wearer, the belief of the wearer. By comparing these attributes of more dimensions, more accurate and detailed evaluations are performed and a more complete evaluation matrix is obtained.

Finally, in step S4, the score information is generated based on the matching result obtained in the evaluation in step S3. The rating information represents the beauty degree the eyeglasses are added to the wearers, which may for example be obtained directly from the above-mentioned evaluation matrix or may be given to the matrix by a weighted fractional algorithm. The rating information may comprise an image of the wearer wearing the selected eyeglasses and a corresponding score to indicate to which extent beauty degree the eyeglasses increase to the wearer, such as an increase of 10 points, or reduce of 10 points (100 points in total). As it should be, it can also be displayed through other visualization or colors. For example, smiling face and/or green color represents increasing of beauty, crying face and/or yellow represents the reduction of beauty.

The score information and the corresponding image can also be shared through the Internet, especially social networks, so as to facilitate the social interaction in a wider range, and to get more evaluation, to help the wearer to know the beauty effect of wearing eyeglasses more intuitively, and to make a decision of purchasing or not.

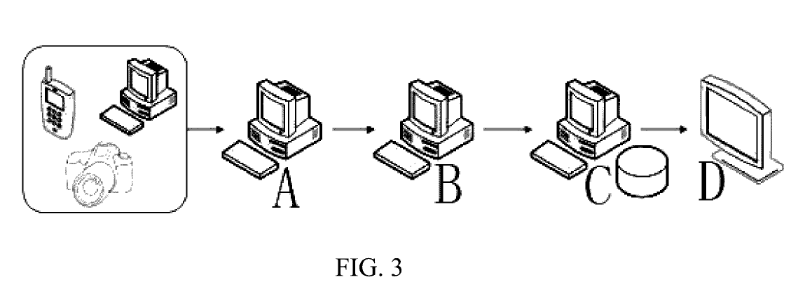

FIG. 3 shows a system for evaluating fitness between a wearer and eyeglasses worn by the wearer, said system comprising:
an attribute data generating module A for generating facial attribute data associated with the wearer and eyeglasses attribute data;
a model establishing module B for establishing wearer model based on the facial attribute data and eyeglasses model based on the eyeglasses attribute data;
   an evaluating module C for comparing the wearer model and the eyeglasses model and evaluating fitness there between; and
   a rating score generating module D for generating and indicating a rating score regarding to which extent the selected eyeglasses improves the wearer visage on the basis of the fitness evaluation result.

The wearer uploads his/her face photos to the attribute data generating module A through a website or an APP, or directly takes his/her own front photo and uploads them through a camera of a digital camera, a computer or a mobile phone. Module A obtains the main facial attribute data points through the detection points. At the same time, it can also be adjusted and improved by a variety of automated comparison tools such as large data experience data and expert assessment programs. Eventually, the facial attribute data of the wearer is obtained.

In addition, the wearer scans the selected physical eyeglasses, or directly selects electronic eyeglasses displayed in the computer, and transfers the relevant data to the module A. The module A generates eyeglasses attribute data by a predetermined algorithm.

The generated facial attribute data and eyeglasses attribute data are sent to the model to build module B. Module B builds metadata for the face recognition model based on the facial attribute data (such as a face recognition map), such as face-square face, chin-pointed chin, eyes distance-middle. At the same time, on the basis of the eyeglasses attribute data, the module B builds the model of the eyeglasses selected by the user and obtains the metadata type of the eyeglasses, such as lens shape-trapezoid, style-half frame, size-small, color-light.

In module C, the above modeling decision is made to deduce the metadata address of the wearer's face and eyeglasses in their kernel database, wherein, the kernel database is pre-set according to the above-mentioned method. Subsequently, the evaluation module C establishes the metadata basic data comparison according to the above-mentioned steps (S31-S34), and the corresponding matching/fitness degree between metadata of the face and the eye model. The score matrix and weights of all the matching data are obtained from the kernel database, for example, from the empirical value data, so as to generate an evaluation matrix. The evaluation module C repeats a comparison operation to match all the matching relationships of the metadata to obtain the final value of the beauty.

Finally, the score generating module D informs the user of the data in a visualized form. The module may be a mobile terminal, a computer terminal, or another terminal having a display device.

In addition, the present invention further relatives to a computer program product for executing the above-mentioned method and operating in the above-mentioned system, which are programmed in a common computer language for execution and updating.

It should be noted that, the embodiments mentioned above are used as examples and cannot be construed as limiting the scope of the invention. On the basis of this, a man skilled in the art could envisage other embodiments having the same function within the scope of protection of the application. For example, the method according to the present invention can further provide recommends to the wearer the eyeglasses with the higher bonus points for the beauty degree obtained in step S3 on the basis of the score result. At the same time, it also may inform the wearer a similar face model of superstars, and show them a photo of wearing the same eyeglasses. For another example, the information for the eyeglasses or the recommended eyeglasses is linked to an online store where the wearer can purchase the eyeglasses directly. In addition, the method according to the present invention can be used not only for eyeglasses but also for other head-mounted devices such as helmets, headphones, face masks and the like which need to be evaluated at the time of wearing. In addition, with the development of science and technology, the functions and types of eyeglasses continue to expand, such as electronic eyeglasses, three-dimensional eyeglasses, so the eyeglasses referred to in the present invention is not limited to the traditional eyeglasses, but also broader scope of eyeglasses.

Various embodiments and various changes and modifications to the disclosed embodiment(s) will become apparent to those skilled in the art. Particularly, otherwise explicitly mentioned, all above described features, alternatives and/or embodiments of the present invention can be combined with each other as far as they are not incompatible or mutually exclusive of others. All such other embodiments, changes, and modifications are intended to fall within the scope of the appended claims:

1. A method for evaluating fitness between a wearer and eyeglasses worn by the wearer, the method comprising steps of:
generating facial attribute data associated with the wearer;
generating eyeglasses attribute data of the eyeglasses;
establishing a wearer model based on the facial attribute data;
establishing an eyeglasses model based on the eyeglasses attribute data;
comparing the wearer model and the eyeglasses model and evaluating the fitness there between; and
generating, based on a result of a fitness evaluation, a rating score information indicative of an extent the eyeglasses improves wearer visage.

2. The method of claim 1, wherein the step of generating the facial attribute data comprises steps of:
capturing at least one image of the wearer, wherein the image has at least two dimensions;
detecting a face in the image; and
characterizing facial attributes of the wearer.

3. The method of claim 1, wherein the wearer receives information including at least one image of the wearer fitted with the eyeglasses along with a corresponding rating score information.

4. The method of claim 3, wherein said information is sharable via social network.

5. The method of claim 3, wherein the wearer receives a recommendation of other eyeglasses which would bring higher rating score.

6. The method of claim 5, wherein at least one of the eyeglasses and a recommended glasses is linked to an on-line store that provides the at least one of the eyeglasses and the recommended eyeglasses for the wearer to purchase.

7. The method of claim 1, wherein the step of establishing wearer model comprises a step of establishing metadata of the wearer, the metadata of the wearer at least comprising:
metadata on face shape of the wearer; and
metadata on eye shape of the wearer.

8. The method of claim 7, wherein the step of establishing eyeglasses model comprises a step of establishing metadata of the eyeglasses which includes characters of a frame and lens of the eyeglasses.

9. The method of claim 8, wherein the step of comparing the wearer model and the eyeglasses model and evaluating fitness there between comprises steps of:
pre-evaluating the wearer model and the eyeglasses model in a kernel database;
comparing and evaluating the metadata of the wearer in the kernel database;
comparing and evaluating the metadata of the eyeglasses in the kernel database; and
generating an evaluation matrix based on the steps of pre-evaluating the wearer model and the eyeglasses model, comparing and evaluating the metadata of the wearer, and comparing and evaluating the metadata of the eyeglasses.

10. The method of claim 9, wherein the kernel database at least comprises a database of wear models and a database of eyeglasses models which are obtained by big data analysis and is adapted to be updated by adding at least one of new wear models and new eyeglasses models when said models are not included in the kernel database.

11. The method of claim 9, wherein the step of creating a rating score further comprises a step of creating weighted scores based on the evaluation matrix.

12. A system for evaluating fitness between a wearer and eyeglasses worn by the wearer, the system comprising:
an attribute data generating module for generating facial attribute data associated with the wearer and eyeglasses attribute data;
a model establishing module for establishing a wearer model based on the facial attribute data and an eyeglasses model based on the eyeglasses attribute data;
an evaluating module for comparing the wearer model and the eyeglasses model and evaluating fitness there between; and
a rating score generating module for generating and indicating a rating score associated with an extent the eyeglasses improves wearer visage based on a result of a fitness evaluation.

13. The system of claim 12, wherein the system further comprises an image capture device for capturing at least one image of the wear, and the system further comprises a displaying device for displaying at least one image showing how the wearer would appear wearing the eyeglasses along with a corresponding rating score.

14. A system for evaluating fitness between a wearer and an eyeglasses frame intended to be fitted by the wearer, the system comprising:
a processor for executing computer-executable instructions;
a computer readable storage media having stored thereon computer-executable instructions for:
generating facial attribute data associated with the wearer;
generating eyeglasses attribute data;
establishing a wearer model based on the facial attribute data;
establishing an eyeglasses model based on the eyeglasses attribute data;
comparing the wearer model and the eyeglasses model and evaluating fitness there between; and
generating, based on a result of a fitness evaluation, a rating score associated with an extent the eyeglasses improves wearer visage.

15. A method for evaluating fitness between a wearer and a head-worn device worn by the wearer, the method comprising steps of:
generating facial attribute data associated with the wearer;
generating attribute data of the head-worn device;
establishing a wearer model based on the facial attribute data;
establishing a head-worn device model based on the attribute data of the head-worn device;
comparing the wearer model and the head-worn device model and evaluating the fitness there between; and
generating, based on a result of a fitness evaluation, a rating score information indicative of an extent the head-worn device improves wearer.

16. The method of claim 2, wherein the wearer receives information including at least one image of the wearer fitted with the eyeglasses along with a corresponding rating score information.

17. the Method of claim 2, wherein the step of establishing the wearer model comprises a step of establishing metadata of the wearer, the metadata of the wearer at least comprising:
metadata on face shape of the wearer; and
metadata on eye shape of the wearer.

18. The method of claim 15, wherein the step of generating the facial attribute data comprises steps of:
capturing at least one image of the wearer, wherein the image is a two-dimensional or three-dimensional image;
detecting a face in the image; and
characterizing facial attributes of the wearer.

19. The method of claim 18, wherein the wearer receives information including at least one image of the wearer fitted with the head-worn device along with a corresponding rating score information.

20. The method of claim 15, wherein the wearer receives information including at least one image of the wearer fitted with the head-worn device along with a corresponding rating score information.
